(19) United States
(12) Patent Application Publication
(10) Pub. No.: US 2023/0106086 A1
(43) Pub. Date: Apr. 6, 2023

(54) MYCOPROTEIN-FREE ENGINEERED FOOD PRODUCT AND METHOD FOR MAKING SAME

(71) Applicant: Sneaky Apron, LLC., Austin, TX (US)

(72) Inventor: Hema Reddy, Austin, TX (US)

(21) Appl. No.: 17/931,833

(22) Filed: Sep. 13, 2022

Related U.S. Application Data
(60) Provisional application No. 63/243,609, filed on Sep. 13, 2021.

(51) Int. Cl. A23L 15/00; A23L 25/00; A23L 5/43; A23L 3/36; A23P 20/20

(52) U.S. Cl. CPC A23L 15/35; A23L 15/20; A23L 25/30; A23L 5/43; A23L 3/363; A23P 20/20; A23V 2002/00

(57) ABSTRACT

An engineered food product includes a mold tray, a molded egg product disposed in the mold tray. The molded egg product includes a white layer conforming to an interior surface of the mold tray, the white layer comprising an annealed hydrocolloidal mixture of one or more nut milks, a vegan thickener, and a first fired salt and a yolk ball supported by the white layer, the yolk ball comprising a matte volume of a second mixture, the second mixture comprising a nut blend, a vegan colorant and a second fired salt.

### CROSS-REFERENCE TO RELATED APPLICATION AND CLAIM OF PRIORITY

This application claims priority under 35 U.S.C. § 119(e) to U.S. Provisional Patent Application No. 63/243,609 filed Sep. 13, 2021, the contents of which are incorporated by reference in their entirety.

### TECHNICAL FIELD

This disclosure relates generally to food science, specifically, to a mycoprotein-free engineered food product and methods for making same.

### BACKGROUND

Improvements in process controls and engineered ingredients as well as growing concerns regarding the environmental and health issues associated with animal-based foods, have spurred innovation in the field of vegan (i.e., free of meat, milk, gelatins and other ingredients made from animals) culinary engineering. Recognizing that “traditional” vegan foods, such as Hindu heritage dishes and the soy-based foods found in many supermarkets may have limited appeal to consumers skeptical of vegan food and reluctant to break with entrenched eating habits, significant advances have been made in engineering vegan foods which mimic the properties (for example, taste, appearance, consistency and mouth feel) of the animal-based originals.

Significant progress has been made in engineering alternatives to meat obtained from slaughtered animals, including, without limitation, “cultivated meats” grown in vitro in laboratories from source cells obtained from animals, as well as “meat analogues,” such as those manufactured and sold by Beyond Meat, which use plant-based proteins. Significant progress in developing satisfactory analogues to chicken and other meat proteins has been made using mycoproteins obtained as a byproduct of fermenting fungi spores (for example, Fusarium venenatum) fed with glucose and other nutrients. Mycoprotein fermentation can yield a protein-rich, dough-like substance that can be molded or otherwise formed to produce a reasonable facsimile of certain animal proteins, most notably chicken.

However, recent advances in engineering foods which emulate the taste, protein content and “feel” of certain meats and poultry have not translated into improved emulation of hard-boiled eggs with vegan ingredients. Skilled artisans will appreciate that emulation of egg products with vegan ingredients, in particular, hard boiled eggs, presents unique and significant challenges. Eggs comprise a variety of egg-specific proteins, including, without limitation, ovalbumin, ovotransferrin, ovomucoid, ovomucin and lysozyme, which depending on how the proteins are cross-linked, combined, or otherwise worked, can be used to stiffen (for example, confectionery icing), lighten (for example, baked goods) other foods, or which, can be heated to produce cooked eggs having a variety of consistencies.

Emulating the consistency and appearance presents a variety interrelated technical challenges, where progress on one dimension of desired performance diminishes progress on another dimension of desired performance. As an illustrative example, the texture and color of a cooked albumin (i.e., white) of a hard-boiled egg can be serviceably emulated based on coconut oil or vegetable oil emulsions, the gains come at a nutritional cost (coconut oil is high in cholesterol) and diminished shelf life. As another illustrative example, the texture and color of cooked albumen can also be serviceably approximated using soy compounds, but this approach raises issues of soy allergies for certain users. Similarly, while aspects of a hard-boiled egg can be emulated using predominantly mycoprotein based formulations, this approach may be highly undesirable for certain users, for whom the protein byproducts of fungal fermentation of base sugars are unacceptably overprocessed or otherwise unpalatable.

The technical challenges associated with providing a suitable vegan-ingredient based emulation of a hard-boiled chicken egg further include developing methods producing such “eggs” at scale and with sufficient shelf life to be a legitimate alternative to the animal-based default.

Accordingly, engineering a vegan-ingredient based emulation of a hard-boiled egg which not only provides good performance in terms of replicating the taste and feel of a boiled chicken egg, nutritional value, compatibility with certain food allergies, storage life, and compatibility with large scale production remains a significant source of technical challenges and opportunities for improvement in the art.

### SUMMARY

This disclosure provides, without limitation, a mycoprotein-free engineered food product and methods for making same.

In a first embodiment, an engineered food product includes a mold tray, a molded egg product disposed in the mold tray. The molded egg product includes a white layer conforming to an interior surface of the mold tray, the white layer comprising an annealed hydrocolloidal mixture of one or more nut milks, a vegan thickener, and a first fired salt and a yolk ball supported by the white layer, the yolk ball comprising a matte volume of a second mixture, the second mixture comprising a nut blend, a vegan colorant and a second fired salt.

In a second embodiment, a method includes combining a nut blend, a first fired salt and a vegan colorant to form a first mixture. The method further includes hydrating the first mixture, mixing the first mixture to diffuse the vegan colorant, freezing a volume of the first mixture to form a yolk ball, wherein the yolk ball is proportioned to fit within a mold tray, combining one or more nut milks, a vegan thickener, a second fired salt and water to form a second mixture, heating the second mixture to a boil, and adding the second mixture to the mold tray to cool to an annealing temperature and form a white layer of an annealed hydrocolloid, at the annealing temperature, floating the yolk ball in the white layer to form an engineered food product, and cooling the engineered food product from the annealing temperature to an ambient temperature.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example of an engineered food product according to various embodiments of this disclosure;

FIG. 2A illustrates an example of an engineered food product according to certain embodiments of this disclosure;

FIG. 2B illustrates an example of part of a mold system for producing engineered food products according to some embodiments of this disclosure;

FIGS. 3A-3B illustrate operations of an example method for producing an engineered food product according to various embodiments of this disclosure;

FIG. 4 illustrates an example of an engineered food product according to various embodiments of this disclosure;

FIG. 5 illustrates an example of a mold system for producing engineered food products according to various embodiments of this disclosure; and

FIG. 6 illustrates an example of an engineered food product according to various embodiments of this disclosure.

### DETAILED DESCRIPTION

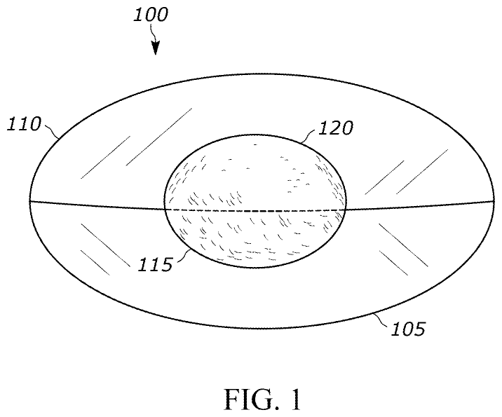

FIGS. 1 through 6, discussed below, and the various embodiments used to describe the principles of this disclosure in this patent document are by way of illustration only and should not be construed in any way to limit the scope of the disclosure. Those skilled in the art will understand that the principles of this disclosure may be implemented in a variety of embodiments.

FIG. 1 illustrates a non-limiting example of an engineered food product 100 according to various embodiments of this disclosure.

Referring to the non-limiting example of FIG. 1, engineered food product 100 (shown in cutaway view) comprises an ovoid half 105 formed of a molded volume of an annealed hydrocolloidal mixture of one or more nut milks, and a first fired salt. According to various embodiments, the molded and annealed hydrocolloidal mixture forming ovoid half 105 is of a bright white color and exhibits a similar initial resistance to moderate compression forces before shearing apart as a hard-boiled chicken egg. An exterior surface 110 of ovoid half 105 may be similarly smooth and exhibit the soft sheen of a hard-boiled chicken egg. Further, ovoid half 105 may, depending on the temperature, be aromatic and exhibit a slightly sulfurous smell. In some embodiments, ovoid half 105 does not contain mycoprotein or soy protein, which provides a clear performance advantage for users with soy allergies or dietary aversions to eating fermentation byproducts.

As shown in the illustrative example of FIG. 1, engineered food product 100 further comprises a yolk ball 115, comprising a volume of a second mixture comprising one or more nut flours, a vegan colorant and a second fired salt. In some embodiments, yolk ball 115 is formed as a hemisphere, such that engineered food product 100 has the appearance of a halved hard-boiled egg. In certain embodiments, including, without limitations, embodiments where it is fully encapsulated by a white layer, yolk ball 115 is formed as a full sphere. Depending on embodiments, the first fired salt may be the same as the second fired salt (for example, Kala Namak salts). In some embodiments, the first and second fired salts may be different salts containing one or more Sulphur salts, including, without limitation, sodium sulfate, sodium bisulfate, sodium bisulfite, sodium sulfide, iron sulfide, and hydrogen sulfide. According to some embodiments, yolk ball 115 is surrounded by, and sits in ovoid half 105, like the yolk of a hard-boiled chicken egg. In some embodiments, the vegan colorant, for example, turmeric or a turmeric extract, imparts a yellow color to yolk ball 115. Composed largely of one or more nut flours (for example, cashew flour), yolk ball 115 closely approximates the consistency and coarse crumbliness of the yolk of a hard-boiled chicken egg. Further, yolk ball 115, like ovoid half 105, may, depending on the temperature, be aromatic and have a slightly sulfurous smell. In some embodiments, yolk ball 115 does not contain mycoprotein or soy protein, which provides a clear performance advantage for users with soy allergies or dietary aversions to eating fermentation byproducts.

Through the methods described herein, in some embodiments, the yolk ball 115 can be produced to have an exterior surface 120, which has a matte exterior, despite the high concentration of nut flour in the mixture forming yolk ball 115. Controlling, or limiting the separation of oils from nut-based ingredients during mixing and heating has been a perennial problem in food science. While it is possible to completely arrest the separation of oils from nut products by hydrogenating fats in the nut-based ingredients thereby converting unsaturated fats into saturated fats, this approach requires a further chemical treatment and processing of the ingredients, which may be generally unacceptable to consumers of vegan foods. Through judicious ingredient selection and sequenced mixing and cooling of the ingredients forming yolk ball 115, the tendency of oils in the nut flours used to make yolk ball 115 to separate and float to the surface of yolk ball 115 (resulting in an unnatural sheen on exterior surface 120) can be suppressed. In this way, certain embodiments of engineered food product 100 provide the nutritional benefits of a nut flour-based yolk (for example, much lower cholesterol than the yolk of a hard-boiled chicken egg), while retaining a familiar appearance and mouth feel for consumers expecting a close copy of a hard-boiled chicken egg.

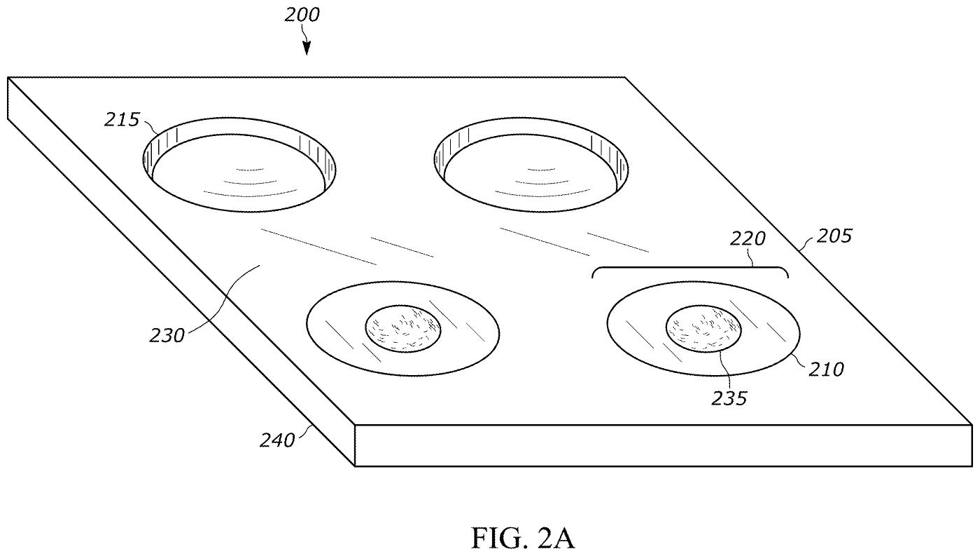

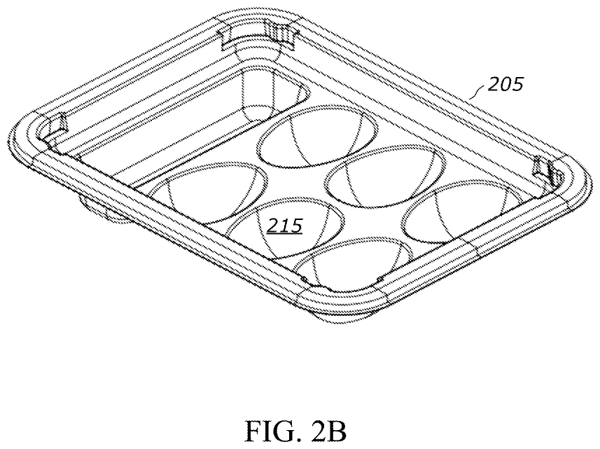

FIG. 2A illustrates an example of an engineered food product 200 according to various embodiments of this disclosure. The embodiment of the engineered food product 200 shown in FIG. 2A is for illustration only and other embodiments could be used without departing from the scope of the present disclosure.

Skilled artisans will appreciate the present scale of production and consumption of animal-based proteins is such that, for vegan alternatives to meaningfully offset the environmental and health costs of broad-based animal farming and meat consumption, it may not be enough for such products to provide a convincing emulation of existing animal-based proteins. Rather, to meaningfully offset the environmental and health costs of mega-scale animal protein production and consumption, vegan solutions must also be able to be produced at large scale and at lower environmental costs.

Certain embodiments according to this disclosure facilitate the production of vegan hard-boiled eggs (for example, engineered food product 100 in FIG. 1) at scale and with diminished environmental impact. Specifically, certain embodiments according to this disclosure may facilitate production speeds and increase yields by eliminating post-casting transfer operations (which take time, and where molded egg products can be damaged in transfer, reducing the yield) and by operating at temperatures which do not degrade currently available, highly recyclable food grade packaging materials.

Referring to the non-limiting example of FIG. 2A, engineered food product 200 comprises a sheet of thermoplastic packaging material, such as, for example, recycled polyethylene terephthalate (“rPET”), or high impact polystyrene (“HIPS”). While not exhaustive of the materials suitable for forming mold tray 205, rPET and HIPS embody the desirable properties such as suitability for use with foods and being highly recyclable. However, such materials may exhibit comparatively lower thermal deflection temperatures relative to other, less recyclable materials. As used in this disclosure, the expression “thermal deflection temperature” of a material encompasses a temperature at which a vessel or other structure made of the material distorts or otherwise fails to maintain its original shape. According to various embodiments, the thermoplastic material used to construct mold tray 205 may be clear or opaque. Further, mold tray 205 may be formed using pigmented (for example, yellow, white, black . . . ) thermoplastic material. As discussed elsewhere in this disclosure, methods according to certain embodiments of this disclosure advantageously reconcile the heating and cooling phases of the annealing process for forming white layer 210 with the limitations of the material forming mold tray 205.

Mold tray 205 comprises at least one or more mold recesses, for example, mold recess 215. According to some embodiments, each mold recess 215 has a profile defining at least part of an outer profile (for example, ovoid half 105 in FIG. 1), of an edible portion of engineered food product 200. In this illustrative example, mold recess 215 has a half ovoid profile, but other shapes are possible, and within the contemplated scope of this disclosure.

As discussed elsewhere in this disclosure, in some embodiments, mold tray 205 provides a forming mold for molded egg products (for example, molded egg product 220), well as a support for downstream operations (for example, cold, or hyperbaric processing), and as part of the packaging for a finished product. In some embodiments, mold tray comprises one or more interstitial spaces 230 in regions between the mold recesses. Interstitial spaces 230 may be proportioned or shaped to facilitate a clean seal between mold tray 205 and an upper mold for casting an upper portion of white layer 210 to fully enclose yolk balls (for example, yolk ball 235) of molded egg product 220. Interstitial spaces 230 may be planar to maximize a sealing area or may include raised or depressed portions to interface and align with mating portions of the upper mold. Mold tray 205 may comprise one or more sidewalls 240 to increase the torsional rigidity of engineered food product 200 and to facilitate serving molded egg product 220.

Referring again to the illustrative example of FIG. 2A, engineered food product 200 comprises one or more molded egg products 220, each of which comprising a white layer 210 conforming to an interior surface (for example, mold recess 215) of mold tray 205. The white layer 210 comprises an annealed hydrocolloidal mixture of one or more nut milks (for example, cashew milk, almond milk, coconut milk or pea milk), a vegan thickener and a first fired salt. The vegan thickener may be, for example, at least one of agar, psyllium husk powder, tapioca, arrowroot, or a byproduct of fermenting the one or more nut milks. Molded egg product 220 may further include a yolk ball 235, comprising a matte volume of a second mixture comprising a nut blend (for example, cashew flour, navy bean flour, pea hull flour or pasteurized organic cashew meal), a vegan colorant (for example, turmeric, a turmeric extract, carrot extract, a sweet potato derivative or tomato powder), and a second fired salt. In some embodiments, the first fired salt and the second fired salt are the same fired salt. Yolk ball 235 may further comprise one or more of flax seed, refined coconut oil, a probiotic or a nutritional yeast.

FIG. 2B illustrates a further example of a mold tray 205 suitable for use in creating an engineered food product according to some embodiments of this disclosure. For consistency and convenience of cross-reference elements shown in both FIGS. 2A and 2B are numbered the same.

Referring to the illustrative example of FIG. 2B, in certain embodiments, mold tray 205 has a deeper section, with mold recesses 215 having semi-ovular profiles, to accommodate engineered food products having full egg, or half egg with protruding yolk (i.e., similar to a deviled egg) shapes.

The examples of described with reference to FIGS. 2A and 2B are illustrative, rather than limitative of the scope of embodiments contemplated by this disclosure. Further variations, wherein the molded egg product has a cake, or patty-like form, with opposing flat sides are possible and within the contemplated scope of this disclosure. Other variations, such as variations in which yolk ball 235 is omitted, are also possible. Additionally, while certain embodiments are described herein with reference to molded products, the present disclosure is not so limited. Other embodiments, wherein the engineered food product is formed in whole or in part through other techniques, such as extrusion or layered deposition are possible and within the contemplated scope of this disclosure.

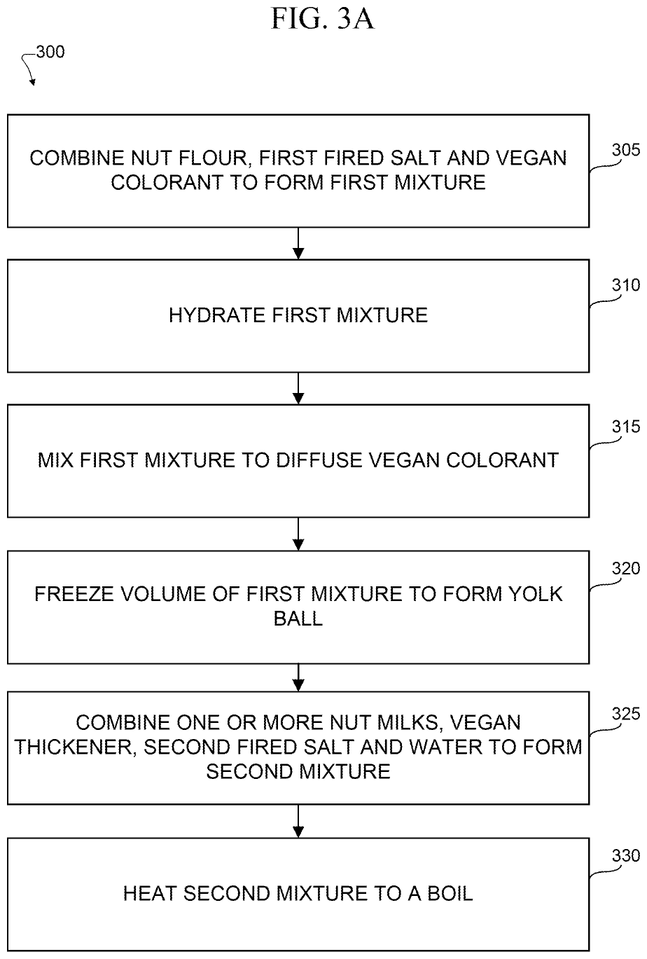

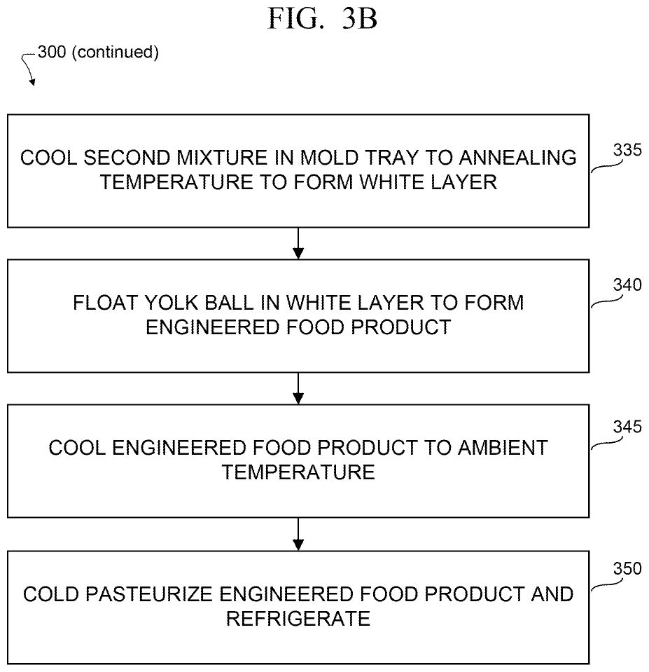

FIGS. 3A and 3B illustrate operations of an example method 300 for creating an engineered food product (for example, engineered food product 100 in FIG. 1, or molded egg product 220 of engineered food product 200 in FIG. 2A). Skilled artisans will appreciate that, while the operations described with reference to the explanatory example of FIGS. 3A and 3B are shown as a linear sequence, this disclosure contemplates embodiments in which operations described in FIGS. 3A and 3B are performed in parallel or in sequences other than as shown in the figures.

Referring to the non-limiting example of FIG. 3A, at operation 305, the process of forming a yolk ball (for example, yolk ball 115 in FIG. 1 or yolk ball 235 in FIG. 2A) according to some embodiments of this disclosure begins by combining at least one nut blend, a vegan colorant and a fired salt to form a first mixture. In some embodiments, the at least one nut blend comprises cashew flour, or a defatted cashew flour, which have been shown to add density to the finished yolk ball, while providing a creamy mouth feel very similar to the yolk of a properly cooked (i.e., cooked until yellow, rather than) hard-boiled chicken egg. Pasteurized organic cashew meal may also be used as a nut flour of the at least one nut blend. Other suitable nut flours for use in the yolk ball include navy bean flour, which is comparatively protein dense, and has a lower fat content than cashew flour. Further examples of nut flours suitable for use in yolk balls include protein rich legume flours, such pea hull flour or lentils, which, while not from nuts, can be used with nut flours as part of a formulation of ingredients providing a convincing facsimile of the yolk of a hard-boiled poultry egg. A non-limiting set of examples of suitable formulations for yolk balls is provided herein as TABLES 16-28.

As noted elsewhere in this disclosure, a persistent technical challenge with nut blends comprising nut flours is avoiding overworking the flour, which, in effect, has a grinding effect on the nut flour grains, causing them to release oil. Excessive mechanical action upon the nut blend at temperatures where liquid nut oil can flow, separates oils from the flour to the point where the exterior surface of the yolk ball is shiny with nut flour oil. For consumers looking for a good emulation of an animal-based hard-boiled egg, such shiny yolks are undesirable, and negatively affect the mouth feel (i.e., by looking and tasting greasy and/or slimy) of the yolk portion of the engineered food product.

To minimize the mechanical action on the nut blend, at operation 305, the remaining ingredients of the yolk ball are combined and pre-mixed separately. In some embodiments, a fired, or “black” salt (for example, kala namak salt (sometimes also referred to as “Himalayan black salt”, or black lava salt) containing traces of one or more sulfur compounds is provided to the mixture. Fired salts may contribute significantly to replicating the “eggy” or mildly sulfurous aromas provided by the naturally occurring sulfur compounds in a hard-boiled animal egg. At operation 305, one or more vegan colorants which, by itself or in combination with other colorants, produces a yolk-like yellow, such as turmeric extract, carrot extract, tomato extract, heme, beet extract, or a sweet potato extract is combined with the fired salt and ingredients other than the nut blend. While turmeric extract is both vegan and imparts a yellow color closely approximating the yellows found in hard-boiled poultry eggs, the high concentration of pigment in turmeric extracts present at the least the following technical challenges. To avoid unnatural variations in the color of the final product, certain vegan colorants, including turmeric extracts need to be thoroughly mixed to ensure uniform concentrations of the colorant. When nut blends are used as a base for the yolk ball, the extensive mixing required to distribute turmeric colorants courts the risk of working the nut blends such that oils in flour separate out, producing an undesirably shiny yolk ball. To mitigate the risk of overworking the nut blend, in certain embodiments, the ingredients combined at operation 305 may further include one or more probiotics, including, without limitation, probiotics containing Pediococcus acidilacti, which has been correlated with improved gut health. In this way, certain embodiments according to this disclosure, may provide a foodstuff which is as palatable to consumers reluctant to give up the taste and consistency of animal-based hard-boiled eggs, but which also provides nutritional benefits not possible in the animal-based originals.

In certain embodiments, a binder, such as flaxseed or refined coconut oil is further added to the yolk ball mixture at operation 305. Additionally, a nutritional yeast product, for example, flakes of deactivated Saccharomyces cerevisae, also added to the mixture at operation 305. In some embodiments, adding nutritional yeast adds to the flavor and nutritional content of the yolk ball, which improving the extent to which the yolk ball exhibits the characteristic crumbliness of the yolk of a hard-boiled chicken egg.

At operation 310, the mixture formed at operation 305 is hydrated with water, and placed in a chiller (for example, a blast chiller, or an air or liquid cooled chiller) at a temperature between 35- and 38-degrees Fahrenheit (1.7-3.3° Celsius) for a predetermined period. In some embodiments, the predetermined period is between 2.5-3.5 hours. In certain embodiments, the predetermined period is between 3.5 and 4.5 hours. In various embodiments, the chilling time may be greater than 4.5 hours. Depending on embodiments, the hydration of the yolk ball mixture at operation 305 may be performed in multiple phases, with a first portion of the water content being introduced prior to the mixture being chilled, and second and subsequent portions of the water content being introduced after the yolk ball mixture has been chilled. Beyond hydrating the nut blends of the material forming the yolk ball, the hydration and chilling performed at operation 310 serves to improve the lubricity of the mixture (thereby reducing internal friction which may cause oils in the nut blend to separate), and to lower the temperature such that the viscosity of the oils in the nut blend is significantly increased, thereby diminishing the tendency of separated nut oils to move within the yolk ball mixture.

Referring to the non-limiting example of FIG. 3A, at operation 315, the chilled and hydrated yolk ball mixture is mixed again only as necessary to diffuse the vegan colorant. Excessive mixing at operation 315 may be undesirable in that it raises the temperature of the yolk ball mixture, and the mechanical work upon the nut blend can cause unwanted separation of oils in the one or more nut blends in the yolk ball mix. For a 75-pound batch of yolk ball mixture, operation 315 may require a mixing time of between 5-10 minutes in a commercial planetary mixer. In some embodiments, the mixing time, and mechanical work on the yolk ball mixture associated with operation 315 may be further reduced by using a specialized high-shear low-speed mixer, such as a double-planetary mixer.

At operation 320, the yolk ball mixture is formed into yolk shaped balls and frozen, semi-frozen or chilled. In some embodiments, the balls may be molded, which contributes to a smooth exterior surface like that of the yolk of a hard-boiled chicken egg. In some embodiments, for example, where throughput and speed are a priority, yolk balls may be formed using a forming machine (for example, a commercial meatball or falafel forming machine). According to certain embodiments, the yolk balls are proportioned to fit within a designated recess (for example, mold recess 215 in FIG. 2A) of the mold tray, while leaving space which can be filled with the white layer.

Once formed, the yolk balls may be stored in a chiller or freezer such that the yolk balls become frozen or semi-frozen. As used in this disclosure, the expression “semi-frozen” encompasses a state where the water in an exterior portion of a yolk ball has frozen, while water in an interior portion of the yolk ball is cold, but not yet frozen. According to various embodiments, once formed and frozen (or semi-frozen) the yolk balls may be maintained at or around 32° Fahrenheit for up to 12 hours in readiness for assembling a molded egg product (for example, molded egg product 220 in FIG. 2A).

Referring to the illustrative example of FIG. 3A, the process of forming a white layer (for example, ovoid half 105 in FIG. 1 or white layer 210 in FIG. 2A) begins at operation 325, wherein a mixture comprising one or more nut milks, a vegan thickener, a fired salt and water are combined. According to certain embodiments, operations 325 and 330 shown in FIG. 3A are performed in a steam jacketed kettle with a mixer or agitator.

According to various embodiments, the one or more nut milks may comprise one or more of a cashew milk, an almond milk, a coconut milk or a pea milk. Cashew milks may be particularly well suited as a base for a hydrocolloidal emulation of the albumen of a hard-boiled poultry egg, in that they yield a white layer of high density, with a slightly “meaty” taste. Almond milks have been found to have a lightening effect on the density of the white layer, and by mixing cashew and almond milks, the consistency of the white layer can be tuned. Advantageously, both cashew milk and almond milk have a white color which substantially matches that of the albumen of a hard-boiled poultry egg. As shown by the example formulations provided in TABLES 1-15, in some embodiments, the at least one nut milk can comprise a coconut milk or a pea milk.

As discussed herein, when used as the base for the set hydrocolloid of the white layer of the engineered food product, nut milks provide multiple benefits, including, without limitation, a similar initial springiness or resistance to compression before breaking as a hard-boiled chicken egg. Additionally, nut milks, like the albumen of a poultry egg, are rich in protein. However, unlike the rice milks, soy milks, and especially vegetable oils used in other vegan egg alternatives, nut milks have high solids contents (for example, between 15-25% by mass, typically between 17-20%) compared to rice and soy milks, whose solids contents are typically on the order of 8-10%. In contrast to soy milks, rice milks, and oils (which have negligible solid content), forming a nut milk based white layer presents unique technical challenges, as the colloidization of the mixture can, if left unchecked, proceed unevenly through the mixture, as the solids in the nut milk may flocculate and form microparticles, or “pellets” of higher or lower density than surrounding regions of the finished hydrocolloid. In practical terms, this results in the finished white layer having a non-uniform, or grainy consistency, which is palpably dissimilar to the highly uniform consistency of the cooked albumen of an animal-based hard-boiled egg. According to some embodiments, the one or more nut milks may comprise coconut milk, whose high oil and fat content adds richness to the white layer and contributes to emulating the soft, smooth sheen characteristic of the cooked white of an animal-based hard-boiled egg.

At operation 325, one or more vegan thickeners may be added to the white layer mixture. Examples of vegan thickeners suitable for use in embodiments of method 300 include, without limitation, agar, psyllium husk powder, arrowroot and tapioca. Further examples of ingredients which may be used as vegan thickeners or as a base for the white layer mixture include rice flours, rice starches, aquafaba, agar and chickpea flour. Additionally, in some embodiments, the nut milks can be pre-thickened through fermentation. For example, the colonies of yeast and lactic acid bacteria found in the kefir grains used to make ayran, yogurts and other preserved milk products can be used to ferment and thicken nut milks. In contrast to gelatin and animal-based thickeners, which can be added to boiling or near-boiling mixtures, certain vegan thickeners such as agar, generally need to be brought up to temperature to operate effectively. Thus, operation 325 is performed at a temperature significantly below the boiling point of the mixture, for example, at between 34°-75° Fahrenheit. According to various embodiments, at operation 325, a fired, or black salt is added to the nut milk mixture, as well as additional water.

At operation 330, the mixture formed at operation 325 is heated from an initial temperature between 34°-75° Fahrenheit to a running boil (for example, to a measured temperature of between 212°-222° Fahrenheit). To ensure uniform colloidization, the mixture is preferably stirred or agitated consistently during the heating process to avoid flocculation of the solids in the one or more nut milks. In certain embodiments, once a running boil has been achieved, the mixture is boiled 2.0-2.5 minutes. In some embodiments, the mixture is boiled between 2.5-3.0 minutes. In certain embodiments, the mixture is boiled between 3.0-5.0 minutes. Subsequently, the heat applied through the kettle is reduced and the mixture is left to simmer for between 1.0-1.5 minutes. In some embodiments, the contents of the kettle may simmer between 1.5-3.0 minutes. As noted above, while in the kettle, the mixture may be continuously agitated or stirred to inhibit flocculation and formation of microparticles in the finished product.

According to certain embodiments, after the white layer mixture has been boiled and simmered, the mixture is cooled to a temperature at or below the thermal deflection temperature of a mold tray (for example, mold tray 205 in FIG. 2A). In some embodiments, the mixture may be cooled in the steam jacketed kettle, by passing cool water through the jacket of the kettle, causing the kettle to act as a heat exchanger. In some embodiments, the white layer mixture is removed at temperature from the kettle and cooled during transfer (for example, through a cooled pipe or contact with a heat exchanger) en route to being dispensed into mold trays. In some embodiments, the white layer mixture is cooled to between 150°-160° Fahrenheit, which is hot enough to avoid substantial setting of the mixture, but cool enough to avoid compromising the structural integrity of the mold tray. In certain embodiments, the white layer may be further cooled to between 140°-150° Fahrenheit.

As shown in the illustrative example of FIG. 3B, at operation 335, the white layer mixture is transferred to recesses (for example, mold recess 215 in FIG. 2A) of one or more mold trays and cooled to an annealing temperature. As used in this disclosure, the expression “annealing temperature” refers to a temperature at which colloidization of the white layer is has proceeded to a point where the mixture has cooled and thickened sufficiently to float a yolk ball, but where colloidization or “setting” has not yet proceeded to a point where the consistency of the final product has been achieved. In some embodiments, the mixture in the mold trays may be cooled to the annealing temperature through exposure to the ambient air (for example, air maintained at a temperature between 65°-75° Fahrenheit) for between 30-60 minutes. In certain embodiments, the mold trays and their contents may be placed in a blast chiller (for example, a commercial blast chiller, such as the Nordika-11 by Carpigiani Corporation). While the annealing temperature can vary based on the white layer formulation, for many formulations, the annealing temperature is reached within ±5° of 110° Fahrenheit.

As shown in the explanatory example of FIG. 3B, at operation 340, frozen (or semi-frozen or chilled) yolk balls (for example, frozen yolk balls formed at operations 305-320 of FIG. 3A) are “floated” in the volumes of white layer mixture at or around the annealing temperature. As used in this disclosure, the expression “float,” as used with respect to construction of engineered food products and molded egg products, encompasses the condition where a portion of a yolk ball (for example, yolk ball 235 in FIG. 2A) is maintained above a top surface of a white layer (for example, white layer 210 in FIG. 2A), solely by buoyant forces provided by white layer 210. To the extent the buoyant force exerted by white layer 210 may increase as colloidization of the white layer progresses, in some embodiments, the yolk balls may be reset to a common depth at operation 340. In certain embodiments, at operation 340, the position of the yolk balls within the white layer mixture may be set mechanically (for example, by a mold or retaining apparatus), rather than through the natural buoyancy of the yolk ball in the cooling white layer mixture.

According to various embodiments, at operation 345, the engineered food product comprising the molded egg product(s) and the mold tray is further cooled to the temperature of the ambient atmosphere (for example, between 65°-75° Fahrenheit). In various embodiments, at operation 345, the molded egg product(s) may be finished, such as by trimming excess yolk ball (to achieve a substantially flat surface), or by applying seasonings.

According to various embodiments, at operation 350 the engineered food product is sealed, such that molded egg products are hermetically sealed between the mold tray and a layer of sealing film. The sealed engineered food products may then be cold processed to enhance shelf life. During cold processing, the engineered food products are submerged in cold water (typically between 39°-50° Fahrenheit) in a hyperbaric chamber containing the cold water and a volume of air. The air in the chamber is pressurized to a pressure of between 40,000-90,000 pounds per square inch (“psi”), causing a proportional isostatic pressure to be transmitted to the engineered food product. During cold processing, the pressure exerted upon the engineered food product through the surrounding water exceeds the maximum pressure(s) at which the naturally present bacteria, yeasts, viruses and other spoilants in the engineered food product can no longer survive or remain operationally intact. Cold processing may, in some embodiments, proceed until the engineered food product is fully pasteurized. In some embodiments, cold processing may be cut short at a point where the storage life of the engineered food product is enhanced, but not fully pasteurized. Following cold processing, the engineered food products may be packaged and refrigerated. Certain embodiments according to the present disclosure have been shown to have a refrigerated shelf life of at least 90 days.

Skilled artisans will appreciate that the examples described with reference to FIGS. 3A and 3B are explanatory and not limitative of the scope of the present disclosure. For example, in some embodiments, it may be possible to omit the step of chilling the yolk mixture in order to change the consistency of yolk portion of the end product. By avoiding the step of chilling the yolk material, certain embodiments according to this disclosure may have a “runnier” yolk portion, more typical of poached or soft-boiled animal-based eggs. The present disclosure contemplates a wide range of embodiments and possible implementations, as illustrated by Tables 1-25 below, which provide a non-exhaustive set of formulations for producing yolk balls and white layers according to this disclosure.

According to some embodiments, the one or more nut milks used to form the white layer may comprise cashew, almond and pea milks.

TABLE 1
Example White Layer Formulation

| | % of Formulation |
|---|---|
| Ingredient | (by mass) |
| Almond Milk (17% milk solids by mass) | 19 |
| Cashew Milk (20% milk solids by mass) | 17 |
| Pea Milk (for example, RIPPLE ® pea milk) | 10 |
| Water | 44 |
| Coconut Milk | 8 |
| Agar | 1.25 |
| Black Salt | 0.75 |

According to some embodiments, the one or more nut milks used to form the white layer may comprise almond, cashew and/or coconut milks.

TABLE 2
Example White Layer Formulation

| | % of Formulation |
|---|---|
| Ingredient | (by mass) |
| Almond Milk (17% milk solids by mass) | 24 |
| Cashew Milk (20% milk solids by mass) | 22 |
| Water | 44 |
| Coconut Milk | 8 |
| Agar | 1 |
| Black Salt | 1 |

TABLE 3A
Example White Layer Formulation

| | % of Formulation |
|---|---|
| Ingredient | (by mass) |
| Almond Milk (17% milk solids by mass) | 11 |
| Cashew Milk (20% milk solids by mass) | 7 |
| Water | 72 |
| Coconut Milk | 8 |
| Agar | 1 |
| Black Salt | 1 |

TABLE 3B
Example White Layer Formulation

| | % of Formulation |
|---|---|
| Ingredient | (by mass) |
| Almond Milk (17% milk solids by mass) | 45.3 |
| Cashew Milk (20% milk solids by mass) | 44 |
| Konjac | 1.2 |
| Coconut Milk | 8 |
| Agar | 1.4 |
| Black Salt | 0.1 |

TABLE 3C
Example White Layer Formulation

| | % of Formulation |
|---|---|
| Ingredient | (by mass) |
| Almond Milk (17% milk solids by mass) | 32.3 |
| Cashew Milk (20% milk solids by mass) | 26.9 |
| Water | 39 |
| Konjac | .7 |
| Agar | 0.85 |
| Black Salt | 0.25 |

TABLE 3D
Example White Layer Formulation

| | % of Formulation |
|---|---|
| Ingredient | (by mass) |
| Almond Milk (17% milk solids by mass) | 11 |
| Cashew Milk (20% milk solids by mass) | 7 |
| Water | 72 |
| Coconut Milk | 8 |
| Agar | 1 |
| Black Salt | 1 |

TABLE 4
Example White Layer Formulation

| | % of Formulation |
|---|---|
| Ingredient | (by mass) |
| Almond Milk (17% milk solids by mass) | 9 |
| Cashew Milk (20% milk solids by mass) | 9 |
| Water | 72 |
| Coconut Milk | 8 |
| Arrowroot | 1 |
| Black Salt | 1 |

According to some embodiments, protein rich, legume-based milks, such as pea milk may be used as the sole nut milk for the white layer.

TABLE 5
Example White Layer Formulation

| | % of Formulation |
|---|---|
| Ingredient | (by mass) |
| Pea Milk (for example, RIPPLE ® pea milk) | 49 |
| Water | 49 |
| Tapioca Starch | 1 |
| Black Salt | 1 |

TABLE 6
Example White Layer Formulation

| | % of Formulation |
|---|---|
| Ingredient | (by mass) |
| Pea Milk (for example, RIPPLE ® pea milk) | 49 |
| Water | 48.75 |
| Psyllium Husk Powder | 1 |
| Black Salt | 1.25 |

According to some embodiments, the vegan thickener may be arrowroot and/or psyllium husk powder.

TABLE 7
Example White Layer Formulation

| | % of Formulation |
|---|---|
| Ingredient | (by mass) |
| Almond Milk (17% milk solids by mass) | 11 |
| Cashew Milk (20% milk solids by mass) | 17 |
| Pea Milk (for example, RIPPLE ® pea milk) | 18 |
| Water | 45 |
| Coconut Milk | 8 |
| Arrowroot | 1 |
| Black Salt | 1 |

TABLE 8
Example White Layer Formulation

| | % of Formulation |
|---|---|
| Ingredient | (by mass) |
| Cashew Milk (20% milk solids by mass) | 30 |
| Pea Milk (for example, RIPPLE ® pea milk) | 16 |
| Water | 47 |
| Coconut Milk | 5 |
| Psyllium Husk Powder | 1 |
| Black Salt | 1 |

According to various embodiments, dehydrated coconut milk, sometimes referred to as coconut powder, may be used in the white layer formulation.

TABLE 9
Example White Layer Formulation

| | % of Formulation |
|---|---|
| Ingredient | (by mass) |
| Almond Milk (17% milk solids by mass) | 24 |
| Cashew Milk (20% milk solids by mass) | 22 |
| Water | 44 |
| Coconut powder | 8 |
| Agar | 1 |
| Black Salt | 1 |

According to some embodiments, thickening of the nut milks of the white layer may be achieved by fermenting the nut milks, with the vegan thickener comprising a byproduct of the fermentation process.

TABLE 10
Example White Layer Formulation

| | % of Formulation |
|---|---|
| Ingredient | (by mass) |
| Almond Milk (Fermented) | 24 |
| Cashew Milk (Fermented) | 23 |
| Water | 44 |
| Coconut powder | 8 |
| Black Salt | 1 |

In various embodiments according to this disclosure, navy bean flour can serve as a vegan thickener and source of nut milk solids in the white layer mixture.

TABLE 11
Example White Layer Formulation

| | % of Formulation |
|---|---|
| Ingredient | (by mass) |
| Pea Milk (for example, RIPPLE ® pea milk) | 24 |
| Water | 55 |
| Navy Bean Flour | 20 |
| Black Salt | 1 |

While embodiments herein have been described with reference to nut milks as the source of nut solids for forming the hydrocolloidal white layer, embodiments according to this disclosure are not so limited, and encompass embodiments using pulverized nuts, or whole nuts, which may be soaked and ground as part of the process of forming the white layer mixture.

TABLE 12
Example White Layer Formulation

| | % of Formulation |
|---|---|
| Ingredient | (by mass) |
| Almond Milk (17% milk solids by mass) | 24 |
| Cashew Powder | 4.6 |
| Water | 61.4 |
| Coconut milk | 8 |
| Agar | 1.3 |
| Black Salt | 0.7 |

TABLE 13
Example White Layer Formulation

| | % of Formulation |
|---|---|
| Ingredient | (by mass) |
| Almond Powder | 4.1 |
| Cashew Powder | 4.6 |
| Water | 85.3 |
| Coconut Cream | 4 |
| Agar | 1 |
| Black Salt | 1 |

TABLE 14
Example White Layer Formulation

| | % of Formulation |
|---|---|
| Ingredient | (by mass) |
| Almond Powder | 4.1 |
| Cashew Powder | 4.6 |
| Water | 78.6 |
| Coconut Milk | 8 |
| Agar | 1 |
| Black Salt | 1 |

TABLE 15
Example White Layer Formulation

| | % of Formulation |
|---|---|
| Ingredient | (by mass) |
| Almonds | 10 |
| Cashews | 8 |
| Water | 72 |
| Coconut | 8 |
| Agar | 1 |
| Black Salt | 1 |

Similarly, embodiments according to the present disclosure encompass a range of formulations of mixtures for forming a yolk ball, as illustrated by the example formulations set forth in TABLES 16-25.

TABLE 16
Example Yolk Ball Formulation

| | % of Formulation |
|---|---|
| Ingredient | (by mass) |
| Cashew Flour | 50 |
| Pea Hull Fiber | 12 |
| Navy Bean Flour | 13 |
| Carrot Extract | 3 |
| Black Salt | 0.5 |
| Probiotics | 0.05 |
| Flaxseed | 2 |
| Nutritional Yeast | 5 |
| Water | 14.45 |

TABLE 17
Example Yolk Ball Formulation

| | % of Formulation |
|---|---|
| Ingredient | (by mass) |
| Cashew Flour | 50 |
| Pea Hull Fiber | 12 |
| Navy Bean Flour | 13 |
| Carrot Extract | 3 |
| Black Salt | 0.5 |
| Pea Protein | 5 |
| Flaxseed | 2 |
| Nutritional Yeast | 5 |
| Water | 9.5 |

TABLE 18
Example Yolk Ball Formulation

| | % of Formulation |
|---|---|
| Ingredient | (by mass) |
| Cashew Flour | 75 |
| Turmeric Extract | 3 |
| Black Salt | 0.5 |
| Pea Protein | 5 |
| Flaxseed | 2 |
| Nutritional Yeast | 5 |
| Water | 14.5 |

TABLE 19
Example Yolk Ball Formulation

| | % of Formulation |
|---|---|
| Ingredient | (by mass) |
| Navy Bean Flour | 75 |
| Turmeric Extract | 3 |
| Black Salt | 0.5 |
| Water | 21.5 |

TABLE 20
Example Yolk Ball Formulation

| | % of Formulation |
|---|---|
| Ingredient | (by mass) |
| Cashew Flour | 75 |
| Turmeric Extract | 3 |
| Black Salt | 0.5 |
| Probiotics | 0.05 |
| Flaxseed | 2 |
| Nutritional Yeast | 5 |
| Water | 14.5 |

TABLE 21
Example Yolk Ball Formulation

| | % of Formulation |
|---|---|
| Ingredient | (by mass) |
| Cashew Flour | 75 |
| Turmeric Extract | 3 |
| Black Salt | 0.5 |
| Refined Coconut Oil | 2 |
| Nutritional Yeast | 5 |
| Water | 14.5 |

TABLE 22
Example Yolk Ball Formulation

| | % of Formulation |
|---|---|
| Ingredient | (by mass) |
| Cashew Flour | 75 |
| Turmeric Extract | 3 |
| Black Salt | 0.5 |
| Pea Protein | 5 |
| Nutritional Yeast | 5 |
| Water | 11.5 |

TABLE 23
Example Yolk Ball Formulation

| | % of Formulation |
|---|---|
| Ingredient | (by mass) |
| Cashew Flour | 75 |
| Turmeric Extract | 3 |
| Black Salt | 0.5 |
| Pea Protein | 5 |
| Water | 16.5 |

TABLE 24
Example Yolk Ball Formulation

| | % of Formulation |
|---|---|
| Ingredient | (by mass) |
| Cashew Flour | 60 |
| Pea Hull Flour | 15 |
| Turmeric Extract | 3 |
| Black Salt | 0.5 |
| Probiotics | 0.05 |
| Nutritional Yeast | 5 |
| Water | 16.45 |

TABLE 25
Example Yolk Ball Formulation

| | % of Formulation |
|---|---|
| Ingredient | (by mass) |
| Cashew Flour | 59 |
| Vegan Masking Agent (for example, | 1 |
| as produced by Innova Flavors) | |
| Turmeric Extract | 3 |
| Black Salt | 0.5 |
| Probiotics | 0.05 |
| Nutritional Yeast | 5 |
| Water | 16.45 |

TABLE 26
Example Yolk Ball Formulation

| | % of Formulation |
|---|---|
| Ingredient | (by mass) |
| Cashews (ground) | 94.78 |
| Colorant | 0.12 |
| Black Salt | 0.35 |
| Konjac | 0.8 |
| Probiotics | 0.05 |
| Nutritional Yeast | 5 |
| Guar Gum | 16.45 |

TABLE 27
Example Yolk Ball Formulation

| | % of Formulation |
|---|---|
| Ingredient | (by mass) |
| Lentils | 94.45 |
| Colorant | 0.2 |
| Black Salt | 0.35 |
| Nutritional Yeast | 4 |
| Xanthan Gum | 1 |

TABLE 28
Example Yolk Ball Formulation

| | % of Formulation |
|---|---|
| Ingredient | (by mass) |
| Lentils | 94.8 |
| Colorant | 0.2 |
| Nutritional Yeast | 4 |
| Bamboo Fiber | 1 |

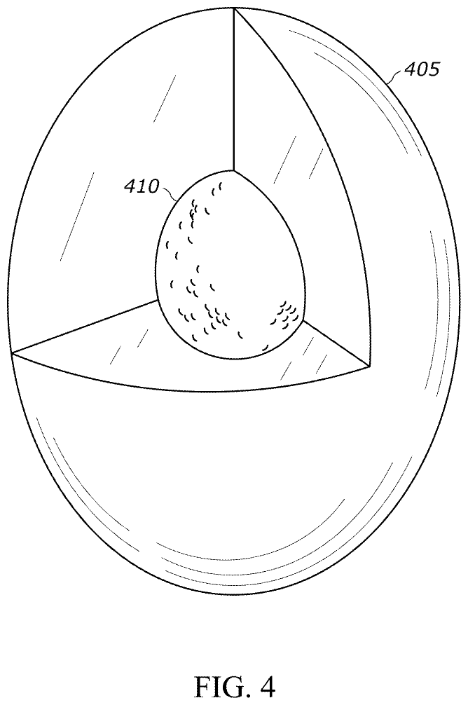

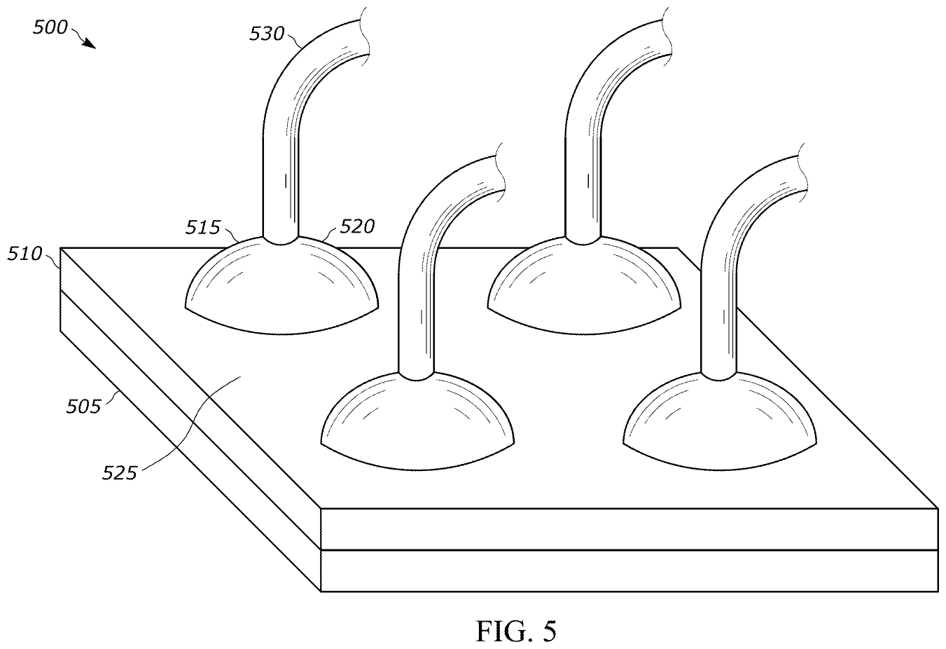

While engineered food products according to some embodiments of the present disclosure have been described with reference to examples comprising half eggs, or eggs in which the yolk is substantially exposed, the present disclosure is not so limited. FIGS. 4 and 5 illustrate aspects of embodiments wherein the yolk ball is fully surrounded by a white layer, thereby adding a further layer of visual similarity between engineered food products according to this disclosure.

Referring to the non-limiting example of FIG. 4, a cutaway view of an example of an engineered food product 400 according to various embodiments of this disclosure is shown. According to some embodiments, engineered food product comprises an exterior white layer 405 (for example, a white layer produced according to operations 325-345 in FIGS. 3A-3B), that surrounds a yolk ball 410 (for example, a yolk ball produced according to operations 305-320 of FIG. 3A). While the engineered food product 400 may be produced using specialized molds for creating stuffed buns, eclairs and other multi-component stuffed foods, this approach requires extracting the formed eggs from a mold, which adds complexity to the manufacturing process and can diminish yield, due to a fraction of the eggs being damaged during transfer.

In certain embodiments, the yield and throughput losses associated with forming “full eggs” in separate molds can be avoided by providing a mold tray and upper mold combination for casting an upper portion of engineered food product 400.

FIG. 5 illustrates an example of a mold system 500 for producing “full eggs” (for example, engineered food product 400 in FIG. 4) according to certain embodiments of this disclosure.

Referring to the non-limiting example of FIG. 5, mold system 500 comprises mold tray 505 (for example, mold tray 205 in FIG. 2A) and a second (or upper) mold 510. According to various embodiments, mold tray 505 acts as a carrier for engineered food products (for example, engineered food product 400 in FIG. 4) during the formation of a white layer, as a carrier/support structure during cold processing, and as part of the packaging of a completed product.

According to certain embodiments, upper mold 510 comprises a plurality of upper mold cavities (for example, upper mold cavity 515) which define a complementary exterior contour of the engineered food product to a corresponding cavity (for example, mold recess 215 in FIG. 2A) of the mold tray. For example, if a mold cavity of mold tray 505 defines a first ovoid half of the engineered food product, then the corresponding upper mold cavity defines the second ovoid half of the engineered food product. As shown in the example of FIG. 5, each upper mold cavity 515 further comprises a filling port 520, through which heated white layer mixture can be added to the chamber defined by the mold cavity and upper mold cavity 515.

In certain embodiments, upper mold 510 comprises one or more interstitial areas 525 disposed between each upper mold cavity 515. The one or more interstitial areas 525 may have a profile contoured to mate with a corresponding interstitial area (for example, interstitial spaces 230 in FIG. 2A), and a compressive force (for example, by a vacuum or mechanical press) forcing upper mold 510 against mold tray 505 and sealing interfaces between mold cavities of mold tray 505 and each upper mold cavity 515 to prevent leakage of egg white mix.

According to certain embodiments, a “whole egg” engineered food product may be produced by first creating a “half egg” engineered food product (for example, molded egg product 220 in FIG. 2A) in mold tray 505. Subsequently, upper mold 510 is positioned over mold tray 505, and sealingly engaged with mold tray 505 (for example, by applying a pinching or compressive pressure across the interstitial spaces of mold tray 505 and upper mold 510, and hot white layer mix is introduced through ports (for example, port 520) in the upper mold and cooled to the annealing temperature or below. In some embodiments, upper mold 510 comprises one or more fill tubes 530 which connect to a filling machine drawing white layer mix from an upstream source (for example, a steam jacketed kettle).

In certain embodiments, upper mold 510 is formed of a similar, highly recyclable polymer, such as rPET or HIPS, as mold tray 505. In some embodiments, upper mold 510 may be formed from a polypropylene (for example, PP or PP+). In this way, upper mold 510 may be used as part of the packaging of the end product and provide a further layer of protection and support for the molded food products during cold processing, packaging and beyond. In some embodiments, fill tubes 530 may be removed as part of the packaging process.

In some embodiments, upper mold 510 is formed from culinary-grade metal (for example, CNC-milled stainless steel) and interstitial area 525 comprises air holes or perforations through which a vacuum force to sealingly (i.e., without liquid white material leaking into interstitial spaces) mate mold tray 505 with upper mold 510.

While embodiments according to the present disclosure have been described with respect to examples in which the constituent layers (for example, the white layer and yolk ball) of an engineered food product emulate the uniform consistency of a properly cooked animal-based hard-boiled egg, the present disclosure is not so limited, and includes engineered food products which emulate animal-based eggs with systemic variations within one or more of the constituent layers. Examples of animal-based boiled egg foods which may be emulated by certain embodiments according to this disclosure include, without limitation, soft-boiled, or “runny” eggs, and Japanese soy-sauce eggs (a.k.a., Shoyu tomago).

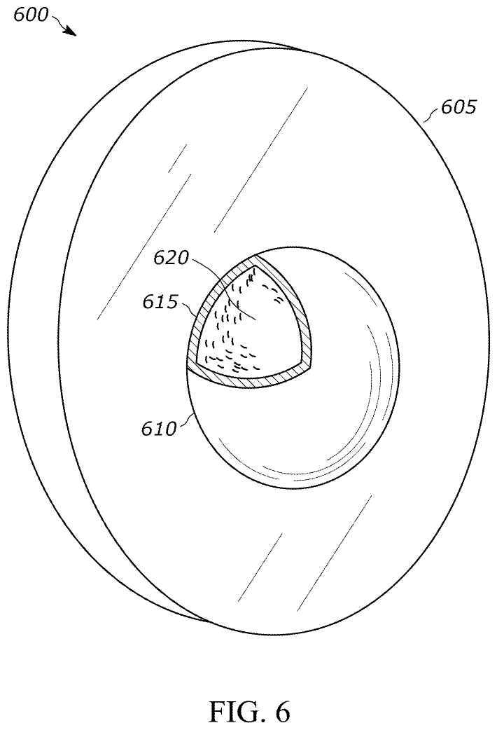

FIG. 5 illustrates, in partial cross-sectional view, an example of an engineered food product 600 according to various embodiments of this disclosure. Referring to the illustrative example of FIG. 6, engineered food product 605 comprises an exterior white layer (for example, ovoid half 105 in FIG. 1, or a white layer formed according to operations 325 to 345 in FIGS. 3A-3B). According to some embodiments, engineered food product 600 further comprises two-layer yolk ball 610, which provides a vegan emulation of the consistency of a soft-boiled, or runny, animal-based egg. Two-layer yolk ball 610 comprises a first, exterior layer formed of a matte yolk layer mix (for example, a mix according to a formulation set forth in one of TABLES 14-23 of this disclosure), and a second, internal layer 620 comprising a variation on the yolk ball mixture with an enhanced oil (for example, coconut oil) or other liquid content which is liquid at serving temperature. According to various embodiments, to maintain the structural integrity (i.e., to keep the liquid of second, internal layer 620 from leaking out while the white cools to an annealing temperature), two-layer yolk ball 610 may be additionally cooled (for example, in a liquid nitrogen bath) prior to being floated in the white layer mixture.

Examples of engineered food products according to this disclosure include engineered food products comprising a mold tray; a molded egg product disposed in the mold tray, the molded egg product comprising a white layer conforming to an interior surface of the mold tray, the white layer comprising an annealed hydrocolloidal mixture of one or more nut milks, a vegan thickener, and a first fired salt; and a yolk ball supported by the white layer, the yolk ball comprising a matte volume of a second mixture, the second mixture comprising a nut blend, a vegan colorant and a second fired salt.

Examples of engineered food products according to this disclosure include engineered food products, wherein the one or more nut milks comprise at least one of a cashew milk, a coconut milk, an almond milk or a pea milk.

Examples of engineered food products according to this disclosure include engineered food products, wherein the vegan thickener comprises at least one of agar, psyllium husk powder, tapioca, arrowroot, or a byproduct of fermenting the one or more nut milks or liquid components of a white layer.

Examples of engineered food products according to this disclosure include engineered food products, wherein the first fired salt comprises black salt.

Examples of engineered food products according to this disclosure include engineered food products, wherein the white layer does not contain mycoprotein, and wherein the yolk ball does not contain mycoprotein.

Examples of engineered food products according to this disclosure include engineered food products, wherein the nut blend comprises at least one of cashew flour, navy bean flour, pea hull flour, or pasteurized organic cashew meal.

Examples of engineered food products according to this disclosure include engineered food products, wherein the vegan colorant comprises at least one of turmeric extract, carrot extract, sweet potato derivative or tomato powder.

Examples of engineered food products according to this disclosure include engineered food products, wherein the white layer fully surrounds the yolk ball.

Examples of engineered food products according to this disclosure include engineered food products, wherein the yolk ball further comprises at least one of flax seed, refined coconut oil, a probiotic or a nutritional yeast.

Examples of engineered food products according to this disclosure include engineered food products, wherein the yolk ball comprises a first portion submerged in the white layer and a second portion extending above an upper surface of the white layer.

Examples of methods for producing engineered food products according to this disclosure include combining a nut blend, a first fired salt and a vegan colorant to form a first mixture, hydrating the first mixture, mixing the first mixture to diffuse the vegan colorant, freezing a volume of the first mixture to form a yolk ball, wherein the yolk ball is proportioned to fit within a mold tray, combining one or more nut milks, a vegan thickener, a second fired salt and water to form a second mixture, heating the second mixture to a boil, and adding the second mixture to the mold tray to cool to an annealing temperature and form a white layer of an annealed hydrocolloid, at the annealing temperature, floating the yolk ball in the white layer to form an engineered food product, and cooling the engineered food product from the annealing temperature to an ambient temperature.

Examples of methods for producing engineered food products according to this disclosure include methods wherein the cooled engineered food product is cold processed by a hyperbaric high-pressure processor.

Examples of methods for producing engineered food products according to this disclosure include sealingly covering the mold tray with a second mold, adding a second volume of the second mixture at a temperature above the annealing temperature to cover the yolk ball, and cooling the second volume of the second mixture to the annealing temperature.

Examples of methods for producing engineered food products according to this disclosure include methods wherein the second mixture is heated to the boil under constant agitation in a kettle, and wherein the second mixture is cooled from a boiling temperature to a temperature above the annealing temperature when transferred from the kettle to the mold tray.

Examples of methods for producing engineered food products according to this disclosure include methods wherein forming the yolk ball comprises combining the nut blend, the first fired salt, the vegan colorant, flax seed and at least one of coconut oil or avocado to form a third mixture, injecting the third mixture to fill a shell comprising the first mixture and freezing the filled shell.

Examples of methods for producing engineered food products according to this disclosure include methods wherein the one or more nut milks comprise at least one of a cashew milk, a coconut milk, an almond milk or a pea milk.

Examples of methods for producing engineered food products according to this disclosure include methods wherein the vegan thickener comprises at least one of agar, psyllium husk powder, tapioca, arrowroot, or a byproduct of fermenting the one or more nut milks or liquid components of a white layer.

Examples of methods for producing engineered food products according to this disclosure include methods wherein the white layer does not contain mycoprotein, and wherein the yolk ball does not contain mycoprotein.

Examples of methods for producing engineered food products according to this disclosure include methods wherein the first fired salt comprises black salt.

Examples of methods for producing engineered food products according to this disclosure include methods wherein the nut blend comprises at least one of cashew flour, navy bean flour, pea hull fiber, or pasteurized organic cashew meal.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle.

What is claimed is:

1. An engineered food product, comprising:
a mold tray (205);
a molded egg product (220) disposed in the mold tray, the molded egg product comprising:
a white layer (210) conforming to an interior surface (215) of the mold tray, the white layer comprising an annealed hydrocolloidal mixture of one or more nut milks, a vegan thickener, and a first fired salt; and
a yolk ball (235) supported by the white layer, the yolk ball comprising a matte volume of a second mixture, the second mixture comprising a nut blend, a vegan colorant and a second fired salt,
wherein the nut blend is comprised of one or more nuts or nut flours.

2. The engineered food product of claim 1,
wherein the one or more nut milks comprise at least one of a cashew milk, a coconut milk, an almond milk or a pea milk.

3. The engineered food product of claim 1, wherein the vegan thickener comprises at least one of agar, psyllium husk powder, tapioca, arrowroot, or a byproduct of fermenting the one or more nut milks.

4. The engineered food product of claim 1,
wherein the first fired salt comprises black salt.

5. The engineered food product of claim 1,
wherein the white layer does not contain mycoprotein, and
wherein the yolk ball does not contain mycoprotein.

6. The engineered food product of claim 1,
wherein the nut blend comprises at least one of cashew flour, navy bean flour, pea hull fiber, or pasteurized organic cashew meal.

7. The engineered food product of claim 1, wherein the vegan colorant comprises at least one of turmeric extract, carrot extract, sweet potato derivative or tomato powder.

8. The engineered food product of claim 1, wherein the white layer (405) fully surrounds the yolk ball (410).

9. The engineered food product of claim 1, wherein the yolk ball further comprises at least one of flax seed, refined coconut oil, a probiotic or a nutritional yeast.

10. The engineered food product of claim 1, wherein the yolk ball comprises a first portion submerged in the white layer and a second portion extending above an upper surface of the white layer.

11. A method comprising:
combining a nut blend, a first fired salt and a vegan colorant to form a first mixture;
hydrating the first mixture;
mixing the first mixture to diffuse the vegan colorant;
freezing a volume of the first mixture to form a yolk ball, wherein the yolk ball is proportioned to fit within a mold tray;
combining one or more nut milks, a vegan thickener, a second fired salt and water to form a second mixture;
heating the second mixture to a boil, and adding the second mixture to the mold tray to cool to an annealing temperature and form a white layer of an annealed hydrocolloid;
at the annealing temperature, floating the yolk ball in the white layer to form an engineered food product; and
cooling the engineered food product from the annealing temperature to an ambient temperature,
wherein the nut blend comprises one or more nuts or nut flours.

12. The method of claim 11, wherein the cooled engineered food product is cold processed by a hyperbaric high-pressure processor.

13. The method of claim 11, further comprising:
sealingly covering the mold tray with a second mold;
adding a second volume of the second mixture at a temperature above the annealing temperature to cover the yolk ball; and
cooling the second volume of the second mixture to the annealing temperature.

14. The method of claim 11, wherein the second mixture is heated to the boil under constant agitation in a kettle, and
wherein the second mixture is cooled from a boiling temperature to a temperature above the annealing temperature when transferred from the kettle to the mold tray.

15. The method of claim 11, wherein forming the yolk ball comprises:
combining the nut blend, the first fired salt, the vegan colorant, flax seed and at least one of coconut oil or avocado to form a third mixture;
injecting the third mixture to fill a shell comprising the first mixture; and
freezing the filled shell.

16. The method of claim 11, wherein the one or more nut milks comprise at least one of a cashew milk, a coconut milk, an almond milk or a pea milk.

17. The method of claim 11, wherein the vegan thickener comprises at least one of agar, psyllium husk powder, tapioca, arrowroot, or a byproduct of fermenting the one or more nut milks.

18. The method of claim 11,
wherein the white layer does not contain mycoprotein, and
wherein the yolk ball does not contain mycoprotein.

19. The method of claim 11,
wherein the first fired salt comprises black salt.

20. The method of claim 11,
wherein the nut blend comprises at least one of cashew flour, navy bean flour, pea hull fiber, or pasteurized organic cashew meal.
